(19) United States
(12) Patent Application Publication
(10) Pub. No.: US 2020/0356372 A1
(43) Pub. Date: Nov. 12, 2020

(54) EARLY INSTRUCTION EXECUTION WITH VALUE PREDICTION AND LOCAL REGISTER FILE

(71) Applicant: QUALCOMM Incorporated, San Diego, CA (US)

(72) Inventors: Rami Mohammad A. AL SHEIKH, Morrisville, NC (US); Derek Robert HOWER, Durham, NC (US)

(21) Appl. No.: 16/406,666

(22) Filed: May 8, 2019

(51) Int. Cl. G06F 9/38; G06F 9/30

(52) U.S. Cl. CPC G06F 9/3802; G06F 9/3012; G06F 9/30043; G06F 9/3869

(57) ABSTRACT

Providing early instruction execution in a processor, and related apparatuses, methods, and computer-readable media are disclosed. In one aspect, an apparatus comprises an early execution engine communicatively coupled to a front-end instruction pipeline and a local register file. The apparatus may be configured to use value prediction wherein all input values of the instructions are actually available early in the pipeline (in the front-end), even before the value producers have executed, thus, providing an opportunity for early executing such instructions, and avoid sending these early executed instructions to the power hungry out-of-order engine that may improve performance as well as energy efficiency. In other aspects, the front-end of the pipeline is augmented with a component for early executing simple operations (e.g., load immediate-loaded registers and subsequent, simple arithmetic, logic and shift operations), such as a dedicated structure is used to store the early executed values, called a Local Register File.

### FIELD OF DISCLOSURE

This disclosure relates generally to microprocessors, and more specifically, but not exclusively, to early execution of instructions by microprocessors.

### BACKGROUND

Conventional microprocessors (also known as a central processing unit, CPU) are used in many applications today and have become a critical component in the overall performance of most microprocessor based electronic devices. The performance of a microprocessor itself may be increased in one of two ways, either by increasing the processor's clock frequency, or by increasing the number of instructions that the processor can execute per cycle. For many workloads, attempts to increase the number of instructions that the processor can execute per cycle is limited by dependencies between instructions. For example:

i1: R1=memory[addr1]; Loads value of register R1 from memory location addr1

### i2: R2=R1+15

### i3: R3=R2*5

### i4: R4=R2+R3

In the sequence above, instruction i3 cannot execute until instructions i1 and i2 have completed (since it is dependent upon R2, which depends on R1), and instruction i4 cannot execute until after R3 has been computed, because an input to i4 depends on an output of i3 (register R3.) Consequently, processor performance when executing code like the above is limited by the dependencies between instructions.

In microprocessors supporting out-of-order execution, the actual execution of an instruction is performed by an execution engine, after passing through many “front-end” pipeline stages. Until an instruction has been executed by this engine, the value of its output is unknown. If the inputs of instructions can be determined before reaching the execution engine, however, there is ample time to execute the instructions before reaching the execution engine, thereby collapsing the instruction dependencies. Further, because execution of an instruction in an out-of-order engine consumes significant power, filtering some set of instructions that need to be performed by the out-of-order execution engine can save power.

Data Value Prediction (or, Value Prediction for short) is a processor performance enhancing technique in which the value(s) produced by an instruction (producer) are predicted before the instruction is executed. Instructions that consume the predicted value(s) (consumers) can speculatively execute before the producer has executed, resulting in higher performance of the processor. The prediction is later confirmed when the producer is executed. If the predicted value did not match the produced value (the trusted value), recovery actions take place. FIG. 1 illustrates an example of how value prediction works. In Step 1, the value predictor is probed as the instruction is fetched, and if a high confidence prediction is found, the value is forwarded to the Value Prediction Engine (VPE) in Step 2. VPE provides the mechanism needed to communicate the predicted values from the value-predicted producers to their consumers. Consumers of the predicted value can use the prediction by reading the stored value out of the VPE rather than waiting on a physical register to be ready. When the predicted instruction executes, the correct value is validated against the speculative value. The predictor updates in Step 3 and, if a misprediction is detected, the affected instructions are flushed and fetch is redirected to the recovery address, in Step 4.

In some conventional microprocessor architectures, a dedicated structure exists in the front-end of the machine to provide certain register inputs without waiting for the producer of those inputs to execute. One example of such a structure is a constant cache, which maintains a set of registers that have been recently loaded with immediate values. Similarly, some other micro-architectures perform early execution of specific registers (e.g., Intel stack engine which executes stack pointer updates). A copy of a single, specific architectural register (the stack pointer register) is maintained in the front-end, allowing for instructions dependent on some stack-pointer writes to execute before those writes have been completed. In both of these examples of front-end register caching, cached register values are restricted to only those values produced by a very limited set of instructions. For example, in the case of the constant cache, only those registers that are written by load-immediate instructions are kept in the cache. In the case of stack pointer register caching, only the output of those instructions that manipulate the stack pointer using push and pop instructions can be cached. Due to these restrictions, the availability of input operands from the front-end register cache is limited and therefore so are the benefits of such early execution.

In general, conventional microprocessor pipelines have considerable delay between instruction fetch and instruction execution, especially behind a cache-miss load dependence, delay limits performance and backs up dependence chain, and out-of-order processors burn considerable power on instructions that could be executed in-order. Accordingly, there is a need for systems, apparatus, and methods that overcome the deficiencies of conventional approaches including the methods, system and apparatus provided hereby.

### SUMMARY

The following presents a simplified summary relating to one or more aspects and/or examples associated with the apparatus and methods disclosed herein. As such, the following summary should not be considered an extensive overview relating to all contemplated aspects and/or examples, nor should the following summary be regarded to identify key or critical elements relating to all contemplated aspects and/or examples or to delineate the scope associated with any particular aspect and/or example. Accordingly, the following summary has the sole purpose to present certain concepts relating to one or more aspects and/or examples relating to the apparatus and methods disclosed herein in a simplified form to precede the detailed description presented below.

In one aspect, an apparatus comprises an early execution engine communicatively coupled to a front-end instruction pipeline; the early execution engine comprises: an early execution unit; a value prediction unit; a local register file; and the early execution engine configured to: fetch an instruction of an instruction fetch group from the front-end instruction pipeline; determine if the instruction is a load instruction; when the instruction is determined to be the load instruction, determine if a predicted value of a load value for the load instruction is available from the value prediction unit; when the predicted value is determined to be available, forward the instruction and the predicted value to the early execution unit, store the predicted value in the local register file, and set a ready bit associated with the predicted value; determine if instructions of the instruction fetch group are ready for execution; and when the instructions of the instruction fetch group are determined to be ready, execute the instructions of the instruction fetch group.

In another aspect, an apparatus comprises an early execution engine communicatively coupled to a front-end instruction pipeline; the early execution engine comprises: means for fetching an instruction of an instruction fetch group from a front-end instruction pipeline; means for determining if the instruction is a load instruction; means for determining if a predicted value of a load value for the load instruction is available from a value prediction unit when the instruction is determined to be the load instruction; means for forwarding the instruction and the predicted value to an early execution unit, storing the predicted value in a local register file, and setting a ready bit associated with the predicted value when the predicted value is determined to be available; means for determining if instructions of the instruction fetch group are ready for execution; and means for executing the instructions of the instruction fetch group when the instructions of the instruction fetch group are determined to be ready.

In still another aspect, a method for providing early instruction execution comprises: fetching an instruction of an instruction fetch group from a front-end instruction pipeline; determining if the instruction is a load instruction; determining if a predicted value of a load value for the load instruction is available from a value prediction unit when the instruction is determined to be the load instruction; forwarding the instruction and the predicted value to an early execution unit, storing the predicted value in a local register file, and setting a ready bit associated with the predicted value when the predicted value is determined to be available; determining if instructions of the instruction fetch group are ready for execution; and executing the instructions of the instruction fetch group when the instructions of the instruction fetch group are determined to be ready.

In still another aspect, a non-transitory computer-readable medium has stored thereon computer-executable instructions which, when executed by a processor, cause the processor to: fetch an instruction of an instruction fetch group from a front-end instruction pipeline; determine if the instruction is a load instruction; when the instruction is determined to be the load instruction, determine if a predicted value of a load value for the load instruction is available from a value prediction unit; when the predicted value is determined to be available, forward the instruction and the predicted value to an early execution unit, store the predicted value in a local register file, and set a ready bit associated with the predicted value; determine if instructions of the instruction fetch group are ready for execution; and when the instructions of the instruction fetch group are determined to be ready, execute the instructions of the instruction fetch group.

Other features and advantages associated with the apparatus and methods disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 illustrates a conventional value prediction system;

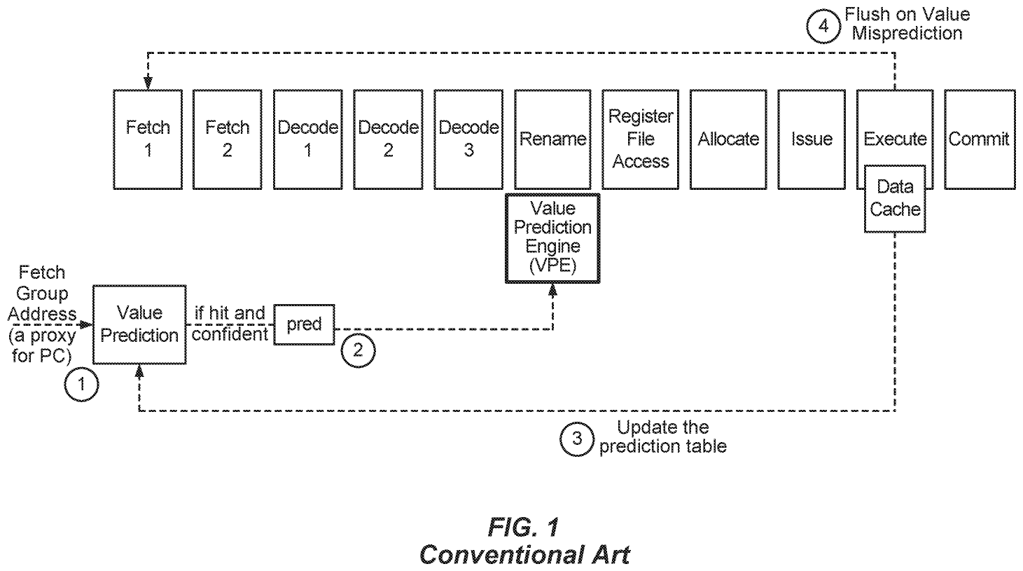

FIG. 2 illustrates an exemplary early execution engine in accordance with some examples of the disclosure;

FIG. 3 illustrates an exemplary partial method for early instruction execution in accordance with some examples of the disclosure;

FIG. 4 illustrates an exemplary early execution engine with support for a dependence chain in accordance with some examples of the disclosure;

FIG. 5 illustrates an exemplary mobile device in accordance with some examples of the disclosure; and

FIG. 6 illustrates various electronic devices that may be integrated with any of the aforementioned apparatus, devices, and methods in accordance with some examples of the disclosure.

In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

The exemplary methods, apparatus, and systems disclosed herein mitigate shortcomings of the conventional methods, apparatus, and systems, as well as other previously unidentified needs. For example, when all input values of many instructions are actually available early in the pipeline (in the front-end), even before the value producers have executed, this provides an opportunity for early executing such instructions, and then avoids sending these early executed instructions to the power hungry out-of-order engine that may improve performance as well as energy efficiency. In some aspects, a front-end of the pipeline is augmented with a component for early executing simple operations (e.g., load immediate-loaded registers and subsequent, simple arithmetic, logic and shift operations). In other aspects, a dedicated structure, called a Local Register File (LRF), is used to store the early executed values. Some aspects disclosed herein may allow an increase in the usefulness of such early execution engines through expanding the scope of registers that can be cached in the front-end of the machine, leveraging the presence of value prediction, and therefore allowing a significant fraction of the instructions to execute early in the front-end and skip the out-of-order engine. In some aspects, no early execution of dependence chains within a fetch group is performed. Alternatively, some aspects may allow early execution of dependence chains within a fetch group by detecting and bypassing dependencies in the early execution engine.

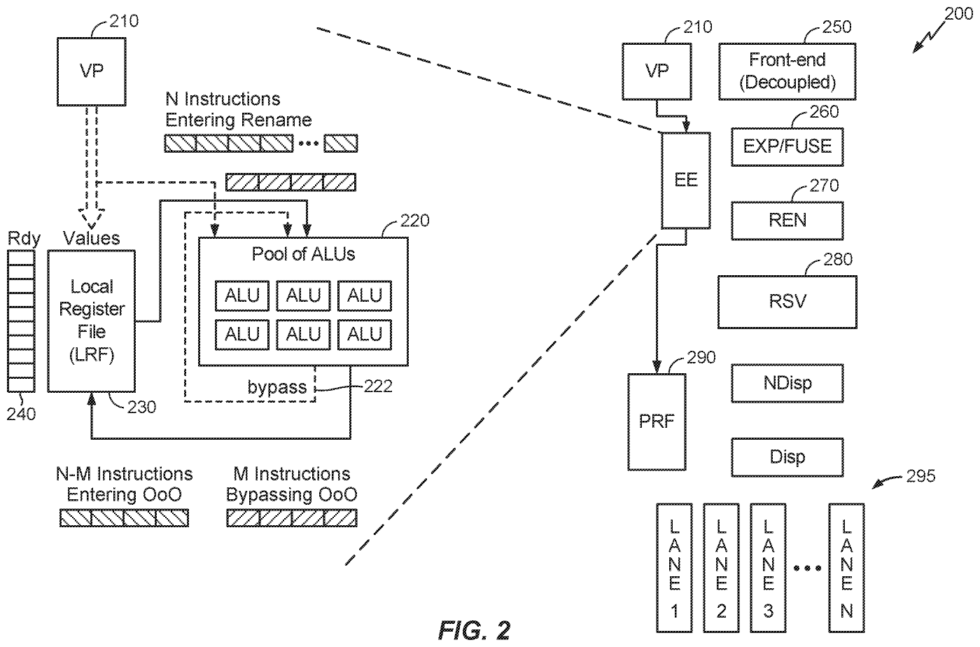

FIG. 2 illustrates an exemplary early execution engine in accordance with some examples of the disclosure. FIG. 2 shows a high-level view of the early execution engine, along with the operations that take place inside it. As shown in FIG. 2, an early execution engine 200 may include a value prediction unit 210, an early execution unit 220, and a local register file (LRF) 230. The LRF 230 may include a plurality of ready bits 240 associated with the values in the LRF 230. The early execution engine 200 may be configured to determine if an instruction is a load instruction; when the instruction is determined to be the load instruction, determine if a predicted value of a load value for the load instruction is available from the value prediction unit 210; when the predicted value is determined to be available, forward the instruction and the predicted value to the early execution unit 220, store the predicted value in the LRF 230, and set a ready bit 240 associated with the predicted value; determine if instructions of the instruction fetch group are ready for execution; and when the instructions of the instruction fetch group are determined to be ready, execute the instructions of the instruction fetch group.

The early execution engine 200 may also include a front-end instruction pipeline 250, an expand/fuse instruction (EXP/FUSE) unit 260, a rename (REN) unit 270, an out of order engine (RSV) 280, a permanent register file (PRF) 290, and a plurality of processing lanes 295 among other units commonly associated with out of order execution engines. The EXP/FUSE unit 260 is configured to take two instructions and fuse the two instructions together into one instruction or take one instruction and expand the one instruction into two instructions. The REN unit 270 is configured to rename a register by assigning a physical address to a logical address. RSV 280 is the out of order engine. As instructions flow through the front-end instruction pipeline 250, two main operations take place in the early execution engine 200:
Dependence checking: identifies dependencies between the instruction fetch group by analyzing the input and output register numbers. The dependence logic also consults the ready bits 240, and the value predictions. The outcome of this is: (a) identify which instructions can be early executed; (b) identify where the instruction input values are coming from (LRF 230, EE bypass network 222, or value prediction unit 210), and Instruction Early Execution (EE): instructions flagged for early execution operate on their inputs and produce their outputs, which get written to the LRF 230 and possibly forwarded to consumers in the current cycle or next cycle.

The EE instructions may bypass the RSV 280 and non-EE instructions (i.e., instructions that cannot be handled by the early execution engine 200 because either it uses an input register not cached by the early execution engine 200, or the operation itself is too complex), as they flow through the early execution engine 200, their output registers are invalidated from the early execution engine LRF 230 by, for example, setting ready bits 240 associated with the values.

In some aspects of the early execution engine 200, significant area and power savings may be achieved by supporting only narrow-width operands. It has been shown in prior work that 61% of all register writes write a single significant byte, and 75% of all register writes write at most two significant bytes, where all remaining bits contain either zeros or ones (representing a sign-extended negative number). Exploiting narrow width operands in the early execution engine 200 may be done by implementing only the lower-order bits of each register in the LRF 230, and commensurately in the early execution unit 220, thereby saving significant area and power. If a register write is detected that overflows this bit width, the resulting register may not be cached in the early execution engine 200.

In the event of a pipeline flush (or punt), LRF 230 state may need to be restored (e.g., invalidate all ready bits 240). In one aspect, recovering the LRF 230 state may include a Fresh Start (FS) (i.e., a complete wipe-out and then restart from scratch). In another aspect, recovering the LRF 230 state may include an accelerated FS (i.e., a complete wipe-out and then reload content from PRF 290: if (PRF[MRTCkpt[reg]].rdy) LRF[reg]=PRF[MRTCkpt[reg]].value), such as by a simple copy during the pipeline stall condition.

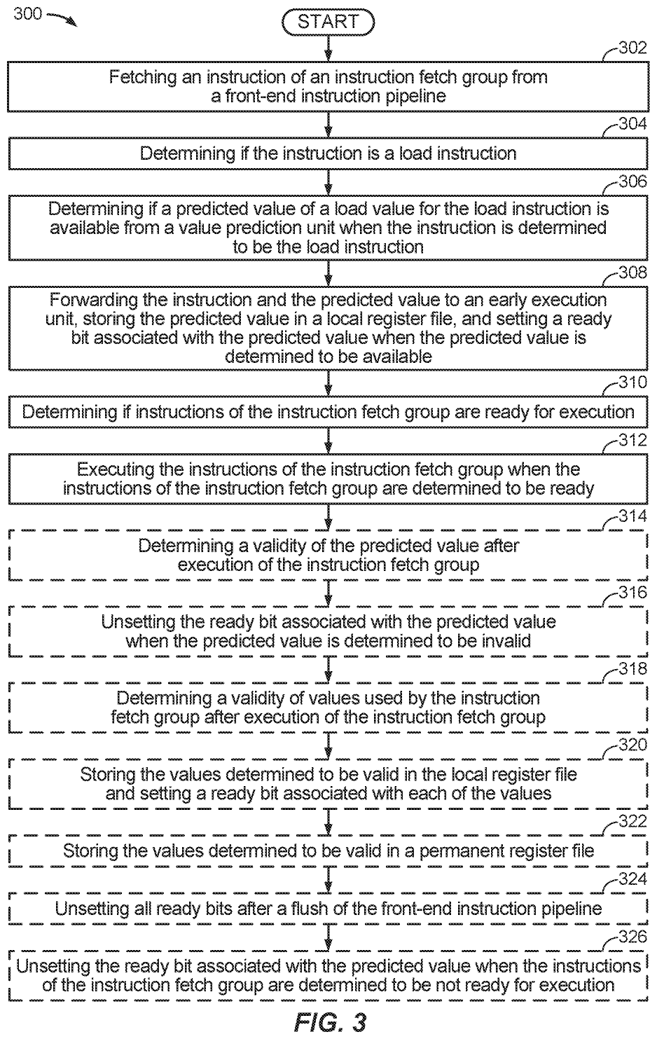

FIG. 3 illustrates an exemplary partial method for early instruction execution in accordance with some examples of the disclosure. As shown in FIG. 3, a partial method 300 begins in block 302 with fetching an instruction of an instruction fetch group from a front-end instruction pipeline. The partial method 300 continues in block 304 with determining if the instruction is a load instruction. The partial method 300 continues in block 306 with determining if a predicted value of a load value for the load instruction is available from a value prediction unit when the instruction is determined to be the load instruction. The partial method 300 continues in block 308 with forwarding the instruction and the predicted value to an early execution unit, storing the predicted value in a local register file, and setting a ready bit associated with the predicted value when the predicted value is determined to be available. The partial method 300 continues in block 310 with determining if instructions of the instruction fetch group are ready for execution. The partial method 300 concludes in block 312 with executing the instructions of the instruction fetch group when the instructions of the instruction fetch group are determined to be ready.

Alternatively, the partial method 300 may conclude in block 314 with determining a validity of the predicted value after execution of the instruction fetch group. Alternatively, the partial method 300 may conclude in block 316 with unsetting the ready bit associated with the predicted value when the predicted value is determined to be invalid. Alternatively, the partial method 300 may conclude in block 318 with determining a validity of values used by the instruction fetch group after execution of the instruction fetch group. Alternatively, the partial method 300 may conclude in block 320 with storing the values determined to be valid in the local register file and setting a ready bit associated with each of the values. Alternatively, the partial method 300 may conclude in block 322 with storing the values determined to be valid in a permanent register file. Alternatively, the partial method 300 may conclude in block 324 with unsetting all ready bits after a flush of the front-end instruction pipeline. Alternatively, the partial method 300 may conclude in block 326 with unsetting the ready bit associated with the predicted value when the instructions of the instruction fetch group are determined to be not ready for execution.

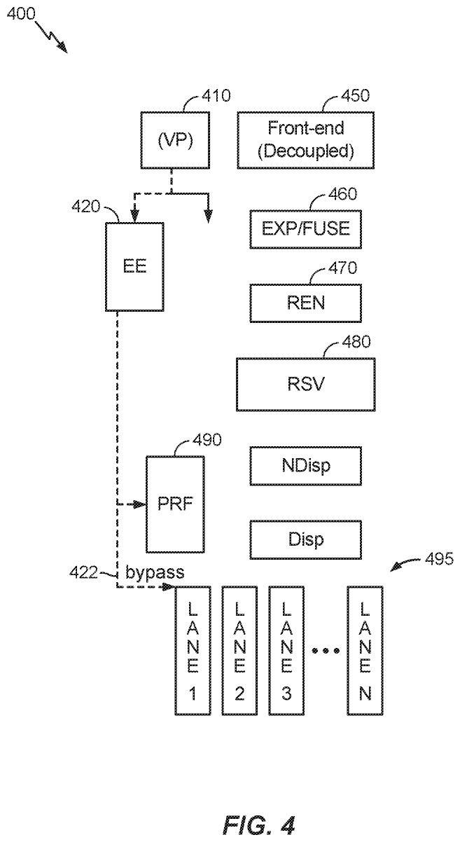

FIG. 4 illustrates an exemplary early execution engine with support for a dependence chain in accordance with some examples of the disclosure. As shown in FIG. 4, an early execution engine 400 (e.g., early execution engine 200) may include a value prediction unit 410 (e.g., value prediction unit 210), an early execution unit 420 (e.g., early execution unit 220, a front-end instruction pipeline 450 (e.g., front-end instruction pipeline 250), an EXP/FUSE unit 460 (e.g., EXP/FUSE unit 260), a REN unit 470 (e.g., REN unit 270), a RSV 480 (e.g., RSV 280), a permanent register file (PRF) 490 (e.g., PRF 290), a plurality of processing lanes 495 (e.g., plurality of processing lanes 295) among other units commonly associated with out of order execution engines, and a RSV bypass network 422.

The early execution engine 400 may be configured to handle dependence chains in the early execution phase. The early execution engine 200 may be used to offload the execution of short dependence chains. The basic idea is to extend the dependence checking logic to identify dependence chains (i.e., producer consumer relationships in the instruction bundle). And then, offloading the entire chain to the early execution unit 420. In this aspect, the LRF is augmented with *busy* bits used to stall the front-end instruction pipeline 450 if a consumer of the EE dependence chain shows up before the chain has completed execution. This may allow dependency chains of length 2 or 3 to set EE busy bits when intra-group dependent instructions (aka dependence chain) are scheduled and the EE busy bits are cleared when the instructions executes. If a consumer of a busy bit shows up, then rename is stalled until the busy bit is cleared. This may allow values produced by EE intra-group dependent instructions to participate in the RSV bypass network 422. In conventional approaches, such EE values are written to a PRF 490 before potential consumers can dispatch the value.

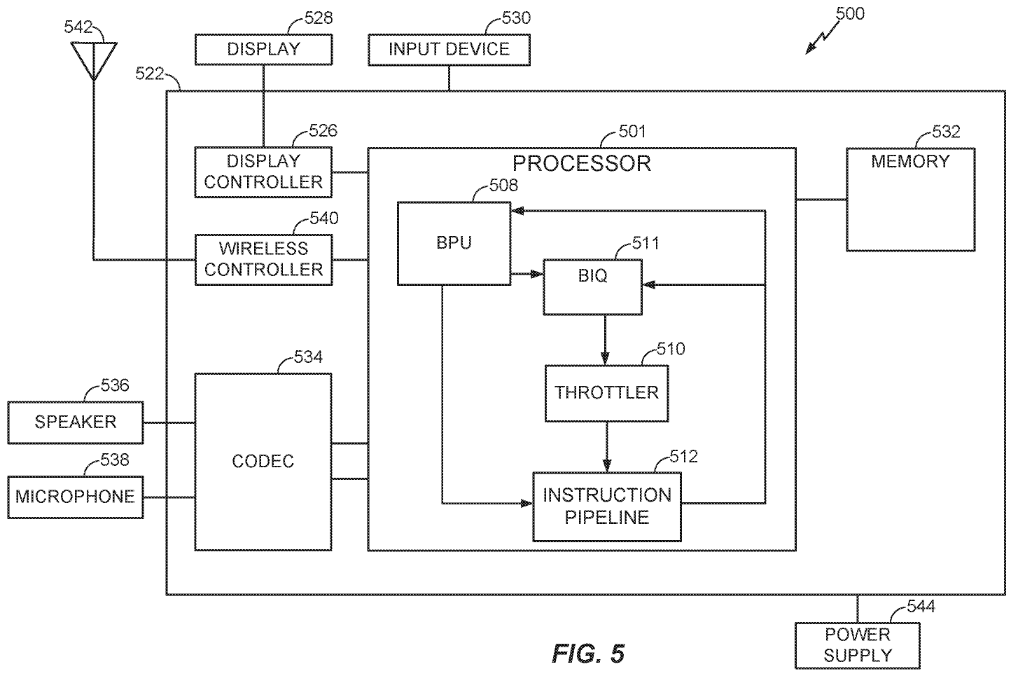

FIG. 5 illustrates an exemplary mobile device in accordance with some examples of the disclosure. Referring now to FIG. 5, a block diagram of a mobile device that is configured according to exemplary aspects is depicted and generally designated 500. In some aspects, mobile device 500 may be configured as a wireless communication device. As shown, mobile device 500 includes processor 501, which may be configured to implement the methods described herein in some aspects. Processor 501 is shown to comprise instruction pipeline 512, buffer processing unit (BPU) 508, branch instruction queue (BIQ) 511, and throttler 510 as is well known in the art. Other well-known details (e.g., counters, entries, confidence fields, weighted sum, comparator, etc.) of these blocks have been omitted from this view of processor 501 for the sake of clarity.

Processor 501 may be communicatively coupled to memory 532 over a link, which may be a die-to-die or chip-to-chip link. Mobile device 500 also include display 528 and display controller 526, with display controller 526 coupled to processor 501 and to display 528.

In some aspects, FIG. 5 may include coder/decoder (CODEC) 534 (e.g., an audio and/or voice CODEC) coupled to processor 501; speaker 536 and microphone 538 coupled to CODEC 534; and wireless controller 540 (which may include a modem) coupled to wireless antenna 542 and to processor 501.

In a particular aspect, where one or more of the above-mentioned blocks are present, processor 501, display controller 526, memory 532, CODEC 534, and wireless controller 540 can be included in a system-in-package or system-on-chip device 522. Input device 530 (e.g., physical or virtual keyboard), power supply 544 (e.g., battery), display 528, input device 530, speaker 536, microphone 538, wireless antenna 542, and power supply 544 may be external to system-on-chip device 522 and may be coupled to a component of system-on-chip device 522, such as an interface or a controller.

It should be noted that although FIG. 5 depicts a mobile device, processor 501 and memory 532 may also be integrated into a set top box, a music player, a video player, an entertainment unit, a navigation device, a personal digital assistant (PDA), a fixed location data unit, a computer, a laptop, a tablet, a communications device, a mobile phone, or other similar devices.

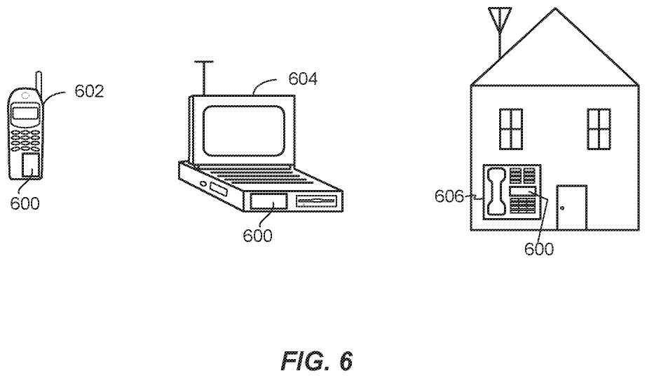

FIG. 6 illustrates various electronic devices that may be integrated with any of the aforementioned apparatus, devices, or methods in accordance with some examples of the disclosure. For example, a mobile phone device 602, a laptop computer device 604, and a fixed location terminal device 606 may include an integrated device 600 as described herein. The integrated device 600 may be, for example, any of the integrated circuits, dies, integrated devices, integrated device packages, integrated circuit devices, device packages, integrated circuit (IC) packages, package-on-package devices described herein. The devices 602, 604, 606 illustrated in FIG. 6 are merely exemplary. Other electronic devices may also feature the integrated device 600 including, but not limited to, a group of devices (e.g., electronic devices) that includes mobile devices, hand-held personal communication systems (PCS) units, portable data units such as personal digital assistants, global positioning system (GPS) enabled devices, navigation devices, set top boxes, music players, video players, entertainment units, fixed location data units such as meter reading equipment, communications devices, smartphones, tablet computers, computers, wearable devices, servers, routers, electronic devices implemented in automotive vehicles (e.g., autonomous vehicles), or any other device that stores or retrieves data or computer instructions, or any combination thereof

It will be appreciated that various aspects disclosed herein can be described as functional equivalents to the structures, materials and/or devices described and/or recognized by those skilled in the art. For example, in one aspect, an apparatus may comprises an early execution engine communicatively coupled to a front-end instruction pipeline; the early execution engine comprising: means for fetching an instruction of an instruction fetch group (e.g., early execution engine 200) from a front-end instruction pipeline; means for determining if the instruction is a load instruction (e.g., early execution engine 200); means for determining if a predicted value of a load value for the load instruction is available from a value prediction unit when the instruction is determined to be the load instruction (e.g., early execution engine 200); means for forwarding the instruction and the predicted value to an early execution unit, storing the predicted value in a local register file, and setting a ready bit associated with the predicted value when the predicted value is determined to be available (e.g., early execution engine 200); means for determining if instructions of the instruction fetch group are ready for execution (e.g., early execution engine 200); and means for executing the instructions of the instruction fetch group when the instructions of the instruction fetch group are determined to be ready (e.g., early execution engine 200). It will be appreciated that the aforementioned aspects are merely provided as examples and the various aspects claimed are not limited to the specific references and/or illustrations cited as examples.

One or more of the components, processes, features, and/or functions illustrated in FIGS. 2-6 may be rearranged and/or combined into a single component, process, feature or function or incorporated in several components, processes, or functions. Additional elements, components, processes, and/or functions may also be added without departing from the disclosure. It should also be noted that FIGS. 2-6 and its corresponding description in the present disclosure is not limited to dies and/or ICs. In some implementations, FIGS. 2-6 and its corresponding description may be used to manufacture, create, provide, and/or produce integrated devices. In some implementations, a device may include a die, an integrated device, a die package, an integrated circuit (IC), a device package, an integrated circuit (IC) package, a wafer, a semiconductor device, a package on package (PoP) device, and/or an interposer.

The word “exemplary” is used herein to mean “serving as an example, instance, or illustration.” Any details described herein as “exemplary” is not to be construed as advantageous over other examples. Likewise, the term “examples” does not mean that all examples include the discussed feature, advantage or mode of operation. Furthermore, a particular feature and/or structure can be combined with one or more other features and/or structures. Moreover, at least a portion of the apparatus described hereby can be configured to perform at least a portion of a method described hereby.

The terminology used herein is for the purpose of describing particular examples and is not intended to be limiting of examples of the disclosure. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, actions, operations, elements, and/or components, but do not preclude the presence or addition of one or more other features, integers, actions, operations, elements, components, and/or groups thereof.

It should be noted that the terms “connected,” “coupled,” or any variant thereof, mean any connection or coupling, either direct or indirect, between elements, and can encompass a presence of an intermediate element between two elements that are “connected” or “coupled” together via the intermediate element.

Any reference herein to an element using a designation such as “first,” “second,” and so forth does not limit the quantity and/or order of those elements. Rather, these designations are used as a convenient method of distinguishing between two or more elements and/or instances of an element. Also, unless stated otherwise, a set of elements can comprise one or more elements.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or other such configurations). Additionally, these sequence of actions described herein can be considered to be incorporated entirely within any form of computer-readable storage medium having stored therein a corresponding set of computer instructions that upon execution would cause an associated processor to perform the functionality described herein. Thus, the various aspects of the disclosure may be incorporated in a number of different forms, all of which have been contemplated to be within the scope of the claimed subject matter. In addition, for each of the examples described herein, the corresponding form of any such examples may be described herein as, for example, “logic configured to” perform the described action.

Nothing stated or illustrated depicted in this application is intended to dedicate any component, action, feature, benefit, advantage, or equivalent to the public, regardless of whether the component, action, feature, benefit, advantage, or the equivalent is recited in the claims.

Further, those of skill in the art will appreciate that the various illustrative logical blocks, modules, circuits, and algorithm actions described in connection with the examples disclosed herein may be implemented as electronic hardware, computer software, or combinations of both. To clearly illustrate this interchangeability of hardware and software, various illustrative components, blocks, modules, circuits, and actions have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the examples disclosed herein may be incorporated directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art including non-transitory types of memory or storage mediums. An exemplary storage medium is coupled to the processor such that the processor can read information from, and write information to, the storage medium. In the alternative, the storage medium may be integral to the processor.

Although some aspects have been described in connection with a device, it goes without saying that these aspects also constitute a description of the corresponding method, and so a block or a component of a device should also be understood as a corresponding method action or as a feature of a method action. Analogously thereto, aspects described in connection with or as a method action also constitute a description of a corresponding block or detail or feature of a corresponding device. Some or all of the method actions can be performed by a hardware apparatus (or using a hardware apparatus), such as, for example, a microprocessor, a programmable computer or an electronic circuit. In some examples, some or a plurality of the most important method actions can be performed by such an apparatus.

In the detailed description above it can be seen that different features are grouped together in examples. This manner of disclosure should not be understood as an intention that the claimed examples have more features than are explicitly mentioned in the respective claim. Rather, the disclosure may include fewer than all features of an individual example disclosed. Therefore, the following claims should hereby be deemed to be incorporated in the description, wherein each claim by itself can stand as a separate example. Although each claim by itself can stand as a separate example, it should be noted that-although a dependent claim can refer in the claims to a specific combination with one or a plurality of claims-other examples can also encompass or include a combination of said dependent claim with the subject matter of any other dependent claim or a combination of any feature with other dependent and independent claims. Such combinations are proposed herein, unless it is explicitly expressed that a specific combination is not intended. Furthermore, it is also intended that features of a claim can be included in any other independent claim, even if said claim is not directly dependent on the independent claim.

It should furthermore be noted that methods, systems, and apparatus disclosed in the description or in the claims can be implemented by a device comprising means for performing the respective actions of this method. Furthermore, in some examples, an individual action can be subdivided into a plurality of sub-actions or contain a plurality of sub-actions. Such sub-actions can be contained in the disclosure of the individual action and be part of the disclosure of the individual action.

While the foregoing disclosure shows illustrative examples of the disclosure, it should be noted that various changes and modifications could be made herein without departing from the scope of the disclosure as defined by the appended claims. The functions and/or actions of the method claims in accordance with the examples of the disclosure described herein need not be performed in any particular order. Additionally, well-known elements will not be described in detail or may be omitted so as to not obscure the relevant details of the aspects and examples disclosed herein. Furthermore, although elements of the disclosure may be described or claimed in the singular, the plural is contemplated unless limitation to the singular is explicitly stated.

What is claimed is:

1. An apparatus comprising an early execution engine communicatively coupled to a front-end instruction pipeline; the early execution engine comprising:
an early execution unit;
a value prediction unit;
a local register file; and
the early execution engine configured to:
fetch an instruction of an instruction fetch group from the front-end instruction pipeline;
determine if the instruction is a load instruction;
when the instruction is determined to be the load instruction, determine if a predicted value of a load value for the load instruction is available from the value prediction unit;
when the predicted value is determined to be available, forward the instruction and the predicted value to the early execution unit, store the predicted value in the local register file, and set a ready bit associated with the predicted value;
determine if instructions of the instruction fetch group are ready for execution; and
when the instructions of the instruction fetch group are determined to be ready, execute the instructions of the instruction fetch group.

2. The apparatus of claim 1, wherein the early execution unit is further configured to determine a validity of the predicted value after execution of the instruction fetch group.

3. The apparatus of claim 2, wherein the early execution engine is further configured to unset the ready bit associated with the predicted value when the predicted value is determined to be invalid.

4. The apparatus of claim 1, wherein the early execution unit is further configured to determine a validity of values used by the instruction fetch group after execution of the instruction fetch group.

5. The apparatus of claim 4, wherein the early execution engine is further configured to store the values determined to be valid in the local register file and set a ready bit associated with each of the values.

6. The apparatus of claim 4, wherein the early execution engine is further configured to store the values determined to be valid in a permanent register file.

7. The apparatus of claim 1, wherein the early execution engine is further configured to unset all ready bits after a flush of the front-end instruction pipeline.

8. The apparatus of claim 1, wherein the early execution engine is further configured to unset the ready bit associated with the predicted value when the instructions of the instruction fetch group are determined to be not ready for execution.

9. The apparatus of claim 1 integrated into an integrated circuit (IC).

10. The apparatus of claim 1 integrated into a device selected from the group consisting a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.

11. An apparatus comprising an early execution engine communicatively coupled to a front-end instruction pipeline; the early execution engine comprising:
means for fetching an instruction of an instruction fetch group from the front-end instruction pipeline;
means for determining if the instruction is a load instruction;
means for determining if a predicted value of a load value for the load instruction is available from a value prediction unit when the instruction is determined to be the load instruction;
means for forwarding the instruction and the predicted value to an early execution unit, storing the predicted value in a local register file, and setting a ready bit associated with the predicted value when the predicted value is determined to be available;
means for determining if instructions of the instruction fetch group are ready for execution; and
means for executing the instructions of the instruction fetch group when the instructions of the instruction fetch group are determined to be ready.

12. The apparatus of claim 11, further comprising means for determining a validity of the predicted value after execution of the instruction fetch group.

13. The apparatus of claim 12, further comprising means for unsetting the ready bit associated with the predicted value when the predicted value is determined to be invalid.

14. The apparatus of claim 11, further comprising means for determining a validity of values used by the instruction fetch group after execution of the instruction fetch group.

15. The apparatus of claim 14, further comprising means for storing the values determined to be valid in the local register file and setting a ready bit associated with each of the values.

16. The apparatus of claim 14, further comprising means for storing the values determined to be valid in a permanent register file.

17. The apparatus of claim 11, further comprising means for unsetting all ready bits after a flush of the front-end instruction pipeline.

18. The apparatus of claim 11, further comprising means for unsetting the ready bit associated with the predicted value when the instructions of the instruction fetch group are determined to be not ready for execution.

19. The apparatus of claim 11 integrated into an integrated circuit (IC).

20. The apparatus of claim 11 integrated into a device selected from the group consisting a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.

21. A method for providing early instruction execution, comprising:
fetching an instruction of an instruction fetch group from a front-end instruction pipeline;
determining if the instruction is a load instruction;
determining if a predicted value of a load value for the load instruction is available from a value prediction unit when the instruction is determined to be the load instruction;
forwarding the instruction and the predicted value to an early execution unit, storing the predicted value in a local register file, and setting a ready bit associated with the predicted value when the predicted value is determined to be available;
determining if instructions of the instruction fetch group are ready for execution; and
executing the instructions of the instruction fetch group when the instructions of the instruction fetch group are determined to be ready.

22. The method of claim 21, further comprising determining a validity of the predicted value after execution of the instruction fetch group.

23. The method of claim 22, further comprising unsetting the ready bit associated with the predicted value when the predicted value is determined to be invalid.

24. The method of claim 21, further comprising determining a validity of values used by the instruction fetch group after execution of the instruction fetch group.

25. The method of claim 24, further comprising storing the values determined to be valid in the local register file and setting a ready bit associated with each of the values.

26. The method of claim 24, further comprising storing the values determined to be valid in a permanent register file.

27. The method of claim 21, further comprising unsetting all ready bits after a flush of the front-end instruction pipeline.

28. The method of claim 21, further comprising unsetting the ready bit associated with the predicted value when the instructions of the instruction fetch group are determined to be not ready for execution.

29. A non-transitory computer-readable medium having stored thereon computer-executable instructions which, when executed by a processor, cause the processor to:
fetch an instruction of an instruction fetch group from a front-end instruction pipeline;
determine if the instruction is a load instruction;
when the instruction is determined to be the load instruction, determine if a predicted value of a load value for the load instruction is available from a value prediction unit;
when the predicted value is determined to be available, forward the instruction and the predicted value to an early execution unit, store the predicted value in a local register file, and set a ready bit associated with the predicted value;
determine if instructions of the instruction fetch group are ready for execution; and
when the instructions of the instruction fetch group are determined to be ready, execute the instructions of the instruction fetch group.

30. The non-transitory computer-readable medium of claim 29, wherein the processor is further configured to determine a validity of the predicted value after execution of the instruction fetch group.
